(19) United States
(12) Patent Application Publication
(10) Pub. No.: US 2024/0273656 A1
(43) Pub. Date: Aug. 15, 2024

(54) REAL ESTATE INFORMATION MATCHING SYSTEM, METHOD, AND PROGRAM

(71) Applicant: FOURLIST CO., LTD., Yokohama-shi, Kanagawa (JP)

(72) Inventors: Kenji ABE, Yokohama-shi (JP); Kuniaki ABE, Yokohama-shi (JP)

(21) Appl. No.: 18/430,625

(22) Filed: Feb. 1, 2024

(30) Foreign Application Priority Data
Feb. 15, 2023 (JP) 2023-021956

(51) Int. Cl. G06Q 50/16; G06Q 30/0201; G06Q 30/0601

(52) U.S. Cl. CPC G06Q 50/16; G06Q 30/0201; G06Q 30/0627; G06Q 30/0639

(57) ABSTRACT

The present invention provides a system that includes a storage unit; an acquiring part; and a matching part, in which the storage unit stores condition information regarding a condition of a real estate for which information is delivered to a customer including customer location information regarding a location of a real estate currently occupied by the customer, the acquiring part performs real estate information acquiring processing acquiring real estate information including real estate location information regarding a location of a real estate, and the matching part performs matching processing extracting real estate information satisfying the condition from the real estate information based on the condition information, and the matching processing includes determination processing that determines whether a location of a real estate exists within a predetermined range from the location of the customer based on the real estate location information and the customer location information.

### BACKGROUND

### Technical Field

The present invention relates to a real estate information matching system, a method, and a program.

### Related Art

Services of delivering information on real estates to customers via websites or the like and mediating the real estates are known.

JP 2019-82937 A discloses a candidate site evaluation system capable of easily evaluating a candidate site in establishment of a facility, which can acquire a first map and a third map obtained by plotting positions (position information) of existing facilities on the first map (i.e., the third map is information obtained by adding position information to the first map), generate a candidate site evaluation model machine-learned using the first map and the third map (a model obtained by learning where a facility of a predetermined business type is likely to exist), evaluate suitability of the candidate site in a target region based on the candidate site evaluation model and a second map indicating the target region to be evaluated for the candidate site, and output an evaluation result.

### SUMMARY

However, although the candidate site evaluation system in JP 2019-82937 A can deliver information on a real estate (candidate site) suitable for each business, information on a real estate suitable for each customer cannot be delivered.

The present invention has been made in view of the above problem, and an object of the present invention is to provide a real estate information matching system, a method, and a program for delivering information regarding real estate suitable for each customer.

In order to solve the above-described problem, the present invention provides a real estate information matching system for delivering real estate information suitable for each customer that includes: a storage unit; an acquiring part; and a matching part, in which the storage unit stores condition information with respect to a condition of a real estate for which information is delivered to a customer including customer location information with respect to a location of a real estate currently occupied by the customer, the acquiring part performs real estate information acquiring processing acquiring real estate information including real estate location information with respect to a location of a real estate, and the matching part performs matching processing extracting real estate information satisfying the condition from the real estate information based on the condition information, and the matching processing includes determination processing that determines whether a location of a real estate exists within a predetermined range from the location of the customer based on the real estate location information and the customer location information.

With such a configuration, even in a case where the customer desires to receive information regarding a real estate near the real estate currently occupied by the customer, such as a case where a site for a parking lot becomes necessary, or a case where the customer considers a transfer of a business facility in a near place to allow users who currently use a business facility of the customer to continue to use the business facility of the customer, it is possible to deliver information regarding a suitable real estate based on a condition set for each customer.

In a preferred mode of the present invention, the customer location information includes condition position information that is position information of the real estate currently occupied by the customer, the real estate location information includes real estate position information that is position information of a real estate, the condition information includes a range condition information with respect to a predetermined range to be set as the condition, and the matching part determines whether a real estate exists within the predetermined range from a set location of the customer based on the real estate position information, the condition position information, and the range condition information as determination processing that determines whether the position of the real estate satisfies the condition.

With such a configuration, it is possible to easily determine whether the real estate is located in a range set as a condition based on latitude and longitude information of the customer location and the latitude and longitude information of the real estate.

In a preferred mode of the present invention, the real estate information matching system further includes a position information acquiring part, the customer location information includes a customer location that is a location of the real estate currently occupied by the customer, the real estate location information includes a real estate location, and the position information acquiring part acquires position information of the customer location to store as condition position information included in the customer location information and acquires position information of the real estate location to store as real estate position information included in the real estate location information.

With such a configuration, it is possible to acquire the latitude and longitude information based on the information regarding the location of the customer and the real estate.

In a preferred mode of the present invention, the acquiring part performs processing that collects real estate information via a network as real estate information acquiring processing.

With such a configuration, it is possible to collect the latest real estate information via the network and deliver information regarding the real estate based on the collected real estate information.

In a preferred mode of the present invention, the real estate information matching system further includes a drawing part, and the drawing part generates a delivering drawing being capable of displaying real estate information extracted by the matching processing from the real estate information extracted by the matching processing.

With such a configuration, the real estate information regarding the real estate suitable for the customer extracted by the matching processing can be easily collected and delivered as a drawing.

In a preferred mode of the present invention, the real estate information matching system further includes a delivering part, and when the matching part extract the real estate information by the matching processing, the delivering part transmits the real estate information with respect to an extracted real estate as an e-mail.

With such a configuration, the real estate information suitable for the customer extracted by the matching processing can be easily delivered to the customer as the e-mail.

In a preferred mode of the present invention, the customer location is a location of a business facility to which a customer belongs.

With such a configuration, regarding the business facility to which the customer belongs, even in a case where the customer desires to receive information regarding the nearby real estate, such as considering purchase of the real estate near the business facility, it is possible to deliver the real estate information suitable for the demand.

The present invention provides a real estate information matching method for delivering real estate information suitable for each customer, the method includes: a storage unit stores condition information with respect to a condition of a real estate for which information is delivered to a customer including customer location information with respect to a location of a real estate currently occupied by a customer; a step of performing real estate information acquiring processing acquiring real estate information including real estate location information with respect to a location of a real estate; and a step of performing matching processing extracting real estate information satisfying the condition from the real estate information based on the condition information, wherein the matching processing includes determination processing that determines whether a location of a real estate exists within a predetermined range from a location of a customer based on the real estate location information and the customer location information, and wherein the acquiring processing and the matching processing are executed by a computer.

The present invention provides a real estate information matching program for delivering real estate information suitable for each customer, the program causes a computer to function as an acquiring part and a matching part, wherein a storage unit stores condition information with respect to a condition of a real estate for which information is delivered to a customer including customer location information with respect to a location of a real estate currently occupied by a customer, wherein the acquiring part performs real estate information acquiring processing for acquiring real estate information including real estate location information with respect to a location of a real estate, wherein the matching part performs matching processing extracting real estate information satisfying the condition from the real estate information based on the condition information, and wherein the matching processing includes determination processing that determines whether a location of a real estate exists within a predetermined range from a location of a customer based on the real estate location information and the customer location information.

### Advantageous Effects of Invention

According to the present invention, it is possible to provide the real estate information matching system, the method, and the program for delivering information regarding real estate suitable for each customer.

### BRIEF DESCRIPTION OF DRAWINGS

FIG. 1 is a block diagram of a real estate information matching system according to the present embodiment;

FIGS. 2A to 2B are hardware configuration diagrams of devices in the present embodiment;

FIGS. 3A to 3C illustrate examples of data configurations in the present embodiment;

FIG. 4 illustrates an example of screen display in the present embodiment;

FIG. 5 illustrates an example of delivering drawings in the present embodiment; and

FIG. 6 illustrates a flow of processing in the present embodiment.

### DETAILED DESCRIPTION

Hereinafter, a real estate information matching system according to an embodiment of the present invention will be described with reference to the drawings. Note that the following embodiment is an example of the present invention, and the present invention is not limited to the following embodiment, and various configurations can be adopted.

In the present embodiment, a configuration, an operation, and the like of a real estate information matching system will be described, however, a real estate information matching method and a real estate information matching program having similar configurations, a recording medium that records the program and is readable by a computer, and the like can also exhibit similar operations and effects. A series of processes according to the present embodiment described below is provided as a computer-executable program, and can be provided via a non-transitory computer-readable recording medium such as a CD-ROM or a flexible disk, and further via a communication line.

The real estate information matching system includes a computer device. The computer device includes an arithmetic device such as a central processing unit (CPU) and a storage device. The computer device can function as a real estate information matching device by executing the real estate information matching program stored in the storage device by the arithmetic device. The real estate information matching method is realized by processing of the computer device including the real estate information matching device.

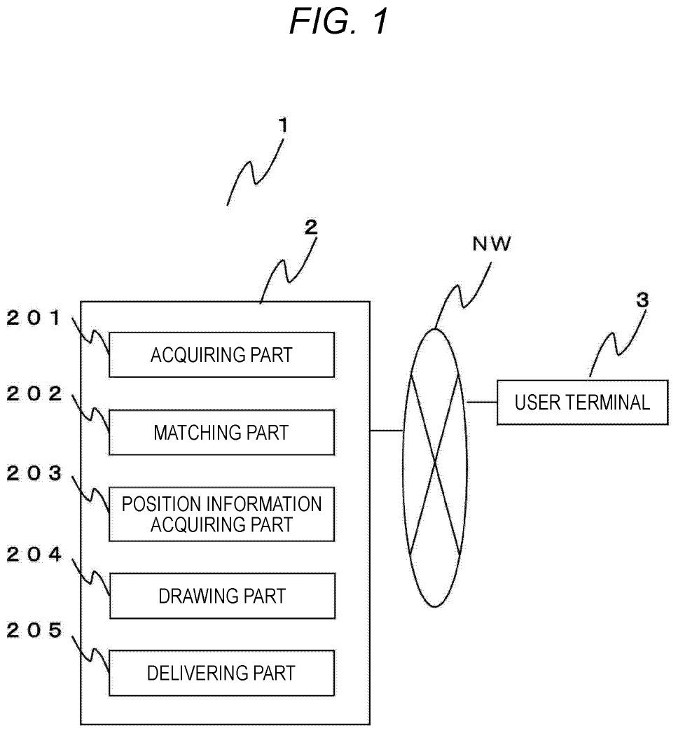

FIG. 1 is a configuration diagram of a real estate information matching system 1 according to the present embodiment. A real estate information matching system 1 illustrated in FIG. 1 includes a real estate information matching device 2 and a user terminal 3, and each component is configured to be communicable via a network NW. In the present embodiment, a user who operates the user terminal 3 is a deliverer such as a real estate company employee who delivers real estate information to a customer, a customer who receives the real estate information, or the like. Although only one user terminal 3 is illustrated in FIG. 1, a plurality of user terminals 3 may be provided. Upon receiving condition information input by the user terminal 3, the real estate information matching device 2 performs matching processing of the real estate information based on the condition information.

In the present embodiment, a matching target is real estate information, and the real estate information satisfying a condition extracted by the matching processing is delivered to the customer. In addition, the condition in the matching of the real estate information is a condition of the real estate for which the information is delivered to the customer. In the present embodiment, the condition in the matching is set by the customer, however, it may be set by a person other than the customer, such as a deliverer that delivers the real estate information to the customer.

In the present embodiment, the real estate information matching system 1 is used as a system that supports a business activity of a real estate company that delivers real estate information to a customer, however, the real estate information matching system 1 may be used as a system that directly delivers information on real estate by a method such as transmission to a terminal of a customer.

As illustrated in FIG. 1, the real estate information matching device 2 includes, as a functional configuration, an acquiring part 201 that performs real estate information acquiring processing of acquiring real estate information, a matching part 202 that extracts real estate information on a real estate suitable for a condition, a position information acquiring part 203 that acquires position information, a drawing part 204 that generates a delivering drawing to be delivered to a customer based on the extracted real estate information, and a delivering part 205 that delivers the real estate information. In the real estate information matching system 1, a part or all of the functional configuration of the real estate information matching device 2 illustrated in FIG. 1 may be realized by the user terminal 3. In addition, the functional configuration of the real estate information matching device 2 may be realized using a plurality of devices instead of one server device.

The real estate information matching device 2 may receive registration of a data set used for learning processing and perform processing related to learning of a model using the registered data set.

In the present embodiment, the acquiring part 201 and the drawing part 204 implement the functional configuration described above by executing a program using an artificial intelligence technology, however, the functional configuration may be implemented by another method. In addition, the artificial intelligence used in the real estate information matching system 1 may be configured by various methods including a learned model by machine learning, deep learning, or the like as long as the above-described functional configuration can be realized. By storing the learned model generated by the learning processing using the data set including input data and output data in a storage unit 212, the real estate information matching device 2 can perform processing using the learned model. Furthermore, in the functional configuration of the acquiring part 201, the drawing part 204, and the like, the number of learned models to be used is not limited, and one functional configuration may include a plurality of learned models, such as learned models learned by using various data sets, and a learned model corresponding to processing executed can be selected from the plurality of learned models.

The acquiring part 201 performs real estate information acquiring processing of acquiring real estate information regarding a real estate. The acquiring part 201 performs the real estate information acquiring processing of acquiring real estate information and storing it in the storage unit 212. In the present embodiment, the real estate information acquiring processing includes a process of collecting information on a real estate on the

Internet and a process of receiving real estate information transmitted from the user terminal 3.

In the present embodiment, the process of collecting the real estate information included in the real estate information acquiring processing is performed by recognizing data on the Internet browser and executing a program for collecting information on the Internet using artificial intelligence having a function of automatically collecting data capable of identifying whether the data is to be stored in a table of the real estate information or in which table of the real estate information the data is to be stored. Furthermore, the process of collecting information regarding the real estate included in the real estate information acquiring processing may be performed by any method as long as the method is a method for collecting information. In a case where the collected data on the real estate cannot be stored as it is in the table of the real estate information, such as a case where a unit of the data on the size of the real estate acquired from the real estate information site is tsubo while the unit of the data to be stored is square meters, the acquiring part 201 may convert the data into a form that can be stored and store the data in the table of the real estate information.

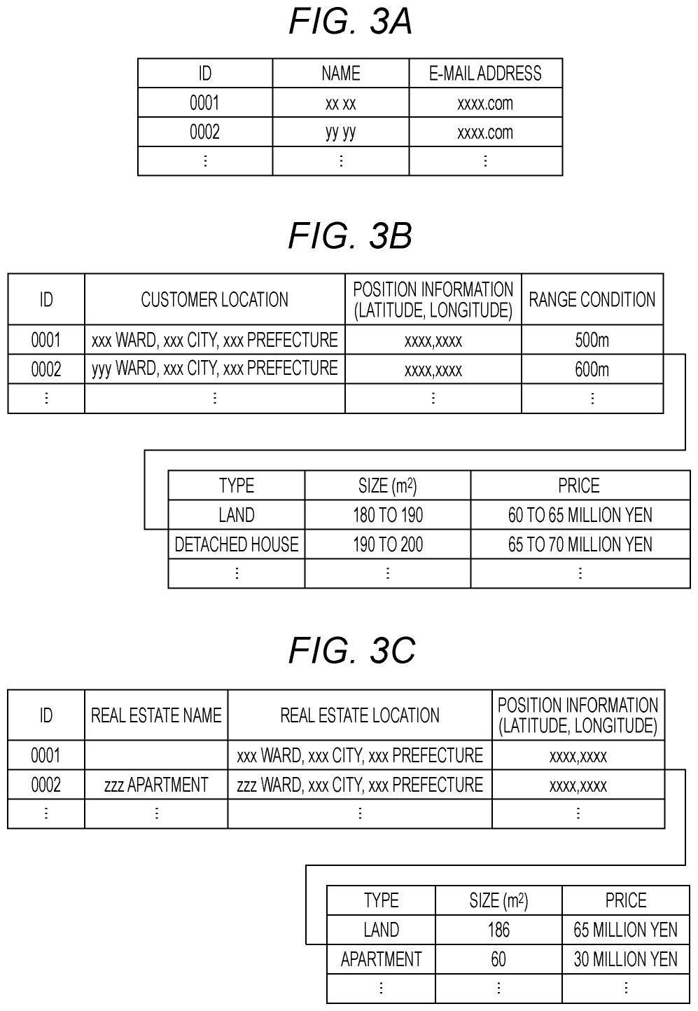

The acquiring part 201 may perform processing of acquiring information on a real estate from the real estate information site with reference to a conversion table for converting data acquired from the real estate information site into a form that can be stored in the table of the real estate information. Upon receiving an input of data such as a text related to a description of a real estate displayed on a real estate information site such as “location is xxx ward, xxx city, xxx prefecture”, “price is 65 million yen”, and “land area is 186 m²”, the acquiring part 201 refers to the conversion table and performs processing of outputting the data as data in a form stored in the real estate information illustrated in FIG. 3C such as xxx ward, xxx city, xxx prefecture, 65 million yen, and 186 m².

In addition, the conversion table referred to when acquiring the real estate information may be set for each real estate information site for collecting the real estate information, and the acquiring part 201 may perform processing related to acquiring the real estate information with reference to the conversion table corresponding to the real estate information site for collecting the real estate information. Each conversion table corresponds to a data configuration of each real estate information site. In a case where the collected data on the real estate cannot be stored as it is in the table of the real estate information because of mismatch of a data type of the collected real estate, such as a case where a unit of the data on the area of the real estate acquired from the real estate information site is tsubo while the unit of the data to be stored is square meters, the acquiring part 201 may output the data of the real estate information converted into a form that can be stored in the table of the real estate information by performing conversion process with reference to the conversion table.

In the present embodiment, the acquiring part 201 is realized by using a learned acquiring model in which learning is performed using text data collected in a real estate information site or the like, image data related to real estate, or the like as input data and real estate information stored in the table of real estate information as output data.

The learned acquiring model used in the acquiring part 201 is a learned model in which learning is performed using, as input data, data related to screen display for delivering information on the real estate information site, including text related to description of the real estate, such as “location is xxx ward, xxx city, xxx prefecture”, “price is 65 million yen”, and “land area is 186 m²”, displayed on the real estate information site, and real estate information for each item stored in a table of real estate information as illustrated in FIG. 3C, such as real estate sales price, rent, location, and size, as output data. The data set in the learning processing of the acquiring model may be data of any format, and the input data of the data set may include image data related to a real estate picture, a floor plan, or the like, and the output data may be image data of a real estate picture, a floor plan, or the like stored in the table of the real estate information.

When the acquiring model receives an input of text data related to description of the real estate, such as “location is xxx ward, xxx city, xxx prefecture”, “price is 65 million yen”, and “land area is 186 m²” included in the real estate site information related to the screen display of the real estate information site, the acquiring model outputs data of xxx ward, xxx city, xxx prefecture, 65 million yen, 186 m², and the like stored in the table of the real estate information illustrated in FIG. 3C as the real estate information included in the text data. In addition, since the format of the input data and the output data of the acquiring model is not limited to the text data, the image data displayed on the real estate information site may be input as the input data, and the image data such as a picture of the real estate may be output as the output data.

In addition, the acquiring part 201 may perform processing related to collection of the real estate information by using an acquiring model corresponding to each real estate information site from a plurality of acquiring models that have learned based on a data set having a different configuration for each real estate information site for acquiring information.

Furthermore, in the present embodiment, the acquiring part 201 performs processing of receiving condition information regarding a condition of real estate for which information is delivered to a customer and customer information regarding the customer from the user terminal 3 and storing the information in the storage unit 212.

The matching part 202 performs matching processing of extracting real estate information of a real estate suitable for conditions based on the condition information regarding the conditions of the real estate for which information is delivered to a customer. In the present embodiment, the matching processing is processing of extracting real estate information regarding real estate satisfying the condition. Furthermore, in the present embodiment, when the acquiring part 201 acquires the real estate information, the matching part 202 performs matching processing of extracting only the latest real estate information satisfying the condition from the acquired latest real estate information, however, processing of extracting all pieces of real estate information satisfying the condition from all pieces of real estate information stored in the storage unit 212 may be performed as the matching processing.

In addition, the matching part 202 performs, as the matching processing, a process including determining whether the real estate information satisfies the condition based on the condition information and extracting the real estate information determined to satisfy the condition by the determination process.

The matching processing executed in the matching part 202 includes determination process as to whether the real estate location exists within a predetermined range from the customer location, based on the real estate position information included in the real estate location information and the condition position information included in the customer location information. In the present embodiment, the determination process as to whether the real estate location is within a predetermined range from the customer location specifically includes determination process as to whether a condition that the real estate location is included within a range of 500 meters from the customer location is satisfied when the range of 500 meters from the customer location is set as the range condition information. In addition, the determination process as to whether the real estate location based on the real estate location information and the customer location information is within the predetermined range from the customer location may be determination process based on the real estate location included in the real estate location information and the customer location included in the customer location information, or determination processing based on the real estate position information included in the real estate location information and the condition position information included in the customer location information, as long as the determination process is based on the real estate location information and the customer location information.

In the present embodiment, the determination process as to whether the condition included in the matching processing is satisfied includes determination process as to whether the price of the real estate falls within the price set as the condition by the customer and whether the size of the real estate set as the condition by the customer is satisfied, however, determination process as to whether the condition is satisfied may be performed with respect to other conditions. Furthermore, the matching processing in the matching part 202 may be executed using artificial intelligence configured by a learned model or the like.

In the present embodiment, the matching part 202 may further receive, from a customer, feedback of the matching processing regarding how much the customer has interested in the real estate information extracted by the matching processing, and perform processing of extracting real estate information having a feature closer to the real estate information in which the customer has more interested in the previous matching processing from the real estate information satisfying the condition as the matching processing. In addition, processing of extracting real estate information having a feature similar to the real estate information in which the customer has an interest in the past based on the past condition information of the customer and the real estate information extracted in the past matching processing may be performed as the matching processing. The matching part 202 may perform processing of enhancing the accuracy related to the matching processing by receiving the evaluation related to the past matching processing and performing learning based on the past matching processing.

The position information acquiring part 203 performs processing of acquiring position information from a location. In the present embodiment, the position information acquiring part 203 acquires position information at the real estate location and stores the position information in the storage unit 212 as the real estate position information included in the real estate location information. Furthermore, the position information acquiring part 203 acquires position information at the customer location and stores the position information in the storage unit 212 as the condition position information included in the customer location information. In the present embodiment, the real estate position information and the condition position information are latitude and longitude at the location, however, they may be information related to other coordinates such as two-dimensional coordinates on a map.

The drawing part 204 generates a delivering drawing for delivering information regarding a real estate to a customer based on real estate information extracted by the matching processing. Upon receiving input of the real estate information, the drawing part 204 generates the delivering drawing in which the received real estate information is displayed. In the present embodiment, the delivering drawing generated by the drawing part 204 is image data related to a drawing such as a flier delivered at the time of selling real estate, and is delivered to a customer by being mailed to the customer as printed matter or transmitted by an e-mail. Furthermore, the drawing part 204 may generate the delivering drawing by a method such as arranging real estate information at a predetermined place based on a template.

The drawing part 204 generates a delivering drawing having a configuration corresponding to the type of real estate from the real estate information extracted by the matching processing. Upon receiving the real estate information, the drawing part 204 may select a drawing generation template based on the type of real estate such as land or an apartment included in the real estate information, and generate the delivering drawing by arranging the real estate information on the selected template.

In the present embodiment, the drawing part 204 is realized using artificial intelligence configured using a learned drawing generation model that has learned data such as real estate information input for creating a drawing such as a delivering drawing as input data and image data related to a drawing for delivering real estate information such as the delivering drawing as output data, however, it may be realized using artificial intelligence configured using a method other than the learning model as long as the artificial intelligence has a drawing generation function. Furthermore, the drawing part 204 may be realized using a method other than artificial intelligence.

In the present embodiment, the drawing part 204 is realized using a learned drawing generation model including a land delivering drawing generation model and an apartment delivering drawing generation model, and generates the delivering drawing using different models for each classification of real estate. In addition, the drawing part 204 may include a plurality of learned drawing generation models corresponding to the real estate information site where the real estate information has been acquired, and generate the delivering drawing using the learned drawing generation model corresponding to the data configuration of each real estate information site where the information on the real estate has been collected.

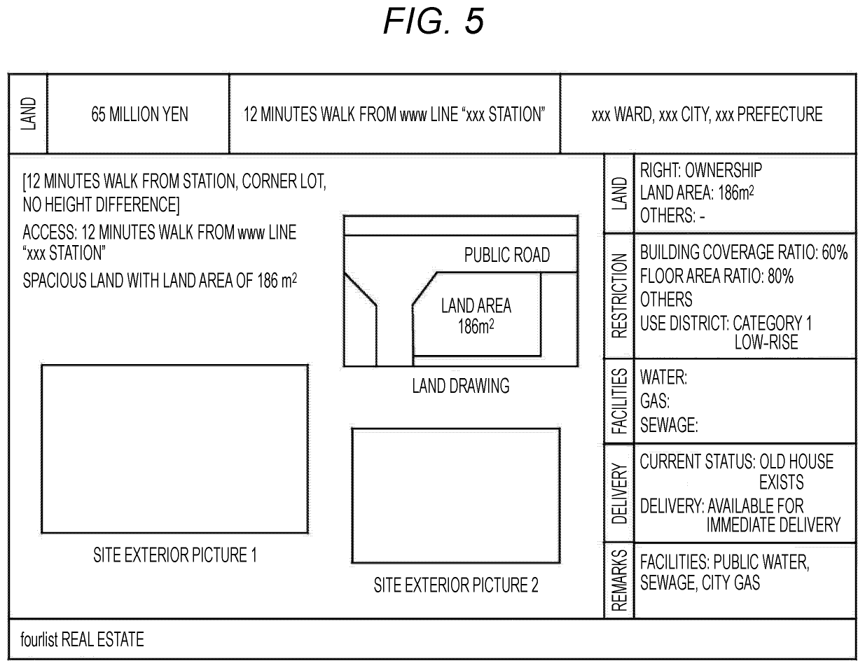

Upon receiving input of data included in real estate information including a price and a location, the drawing generation model outputs image data of the delivering drawing as illustrated in FIG. 5. In the present embodiment, the input real estate information may include image data such as a picture of real estate and a floor plan. In addition, when receiving an input of image data such as the picture of the real estate or the floor plan as real estate information, the drawing model generates a delivering drawing in which image data such as the received picture is arranged.

In the present embodiment, the drawing part 204 generates a delivering drawing including items of real estate information unique to land such as the size of the land and restrictions on the building coverage ratio, the floor area ratio, and the like by using a land delivering drawing generation model for generating a land drawing that delivers information regarding the land, which is a delivering screen illustrated in FIG. 5. The land delivering drawing generation model is a drawing generation model used when the type of real estate is land, and is a learned model that has learned not only real estate information common to real estate, such as a location, a price, and a size, but also real estate information specific to the land, such as the size of the land and restrictions on the building coverage ratio, the floor area ratio, and the like included in the input data, and is a learned model that has learned image data of a drawing, such as a delivering drawing related to sales of the land, as output data.

When receiving real estate information including an item specific to the land such as the size of the land and restrictions on the building coverage ratio, the floor area ratio, and the like as input data, the land delivering drawing generation model outputs image data of a land delivering drawing which is a delivering drawing including display of an item specific to the land such as the size of the land and restrictions on the building coverage ratio, the floor area ratio, and the like.

Furthermore, in the apartment delivering drawing generation model for generating an apartment delivering drawing that delivers information regarding an apartment, the drawing part 204 may generate a delivering drawing including items of real estate information specific to an apartment, such as a floor level and a room number. The apartment delivering drawing generation model is a learned model in which learning is performed using real estate information including an item specific to an apartment such as a floor level or a room number as input data, and image data such as a delivering drawing regarding delivery of real estate information of an apartment including display of an item of real estate information specific to an apartment such as a floor level or a room number as output data.

Upon receiving the real estate information including an item of the real estate information specific to the apartment such as the floor level and the room number as the input data, the apartment delivering drawing generation model outputs the image data of the delivering drawing which is the delivering drawing including the display of the items of the real estate information specific to the apartment such as the floor level and the room number.

In the present embodiment, the drawing part 204 creates a delivering drawing having a similar screen configuration by arranging real estate information regarding a predetermined item in a range determined to some extent, however, it may generate a delivering drawing having a screen configuration completely different for each customer and delivering real estate information, such as a delivering drawing having a screen configuration highlighting an item of interest of a customer.

In the present embodiment, the drawing part 204 further performs sorting processing regarding pictures and the like of real estate arranged in the drawing. In the present embodiment, the drawing part 204 performs sorting processing of classifying image data regarding pictures and drawings of real estate included in the real estate information acquired by the acquiring part 201 for each item of a picture regarding exterior, a picture regarding interior, a drawing regarding real estate such as a floor plan, and the like. The learned drawing model used in the drawing part 204 may be a learned drawing model that has learned, regarding sorting processing, a picture of an exterior, an interior, or the like of real estate, or image data regarding real estate, such as a floor plan, as input data, and a label regarding classification, such as an exterior picture, an interior picture, or a floor plan, as output data. In addition, the drawing part 204 may be configured to use different learned models for each processing, such as using different learned models for processing related to arrangement of real estate information in the drawing and sorting processing.

The drawing part 204 generates the delivering drawings by arranging image data including picture relating to the exterior of the real estate, a picture relating to the interior, a floor plan, and the like classified by the sorting processing. Furthermore, in the present embodiment, the drawing part 204 collects information at a real estate information site or the like, and generates the delivering drawing by arranging an explanation related to real estate acquired as real estate information, however, the delivering drawing may be generated by automatically generating an explanation of real estate described in the delivering drawing and arranging the generated explanation.

In the present embodiment, the drawing part 204 automatically generates the delivering drawing to be delivered to the customer based on the real estate information extracted by the matching processing, however, it may further receive information regarding real estate or a setting regarding the delivering drawing in addition to the extracted real estate information, and perform processing regarding generation of the delivering drawing or editing of the generated delivering drawing based on the received information. Furthermore, in the present embodiment, the drawing part 204 generates the delivering drawing based on the real estate information extracted by the matching processing, however, it may generate the delivering drawing based on the real estate information not extracted by the matching processing.

The delivering part 205 delivers the real estate information extracted by the matching processing. In the present embodiment, the delivering part 205 delivers the real estate information drawn by an e-mail automatically transmitted with the delivering drawings, however, it may deliver the real estate information by a method such as displaying the real estate information on a web page.

In the present embodiment, the delivering part 205 delivers the real estate information by transmitting the delivering drawings via an e-mail, however, it may deliver the real estate information by a method other than e-mail, such as displaying the delivering drawings on a site. In addition, the delivering part 205 may deliver the real estate information for supporting the business activities of the deliverer by performing display processing of a list or the like of the real estate information extracted by the matching processing on the user terminal 3 operated by the deliverer who delivers the real estate information.

In addition, the delivering drawings generated based on the extracted real estate information may be printed as a flier and mailed to the customer. In a case where the delivering drawings are delivered by mail, the delivering part 205 may perform processing related to support of mail such that a list of information regarding a customer such as an address of a customer of a delivery destination, letters to be printed on a label or an envelope for mail, or the like is presented to a deliverer who delivers real estate information by sending a printed matter.

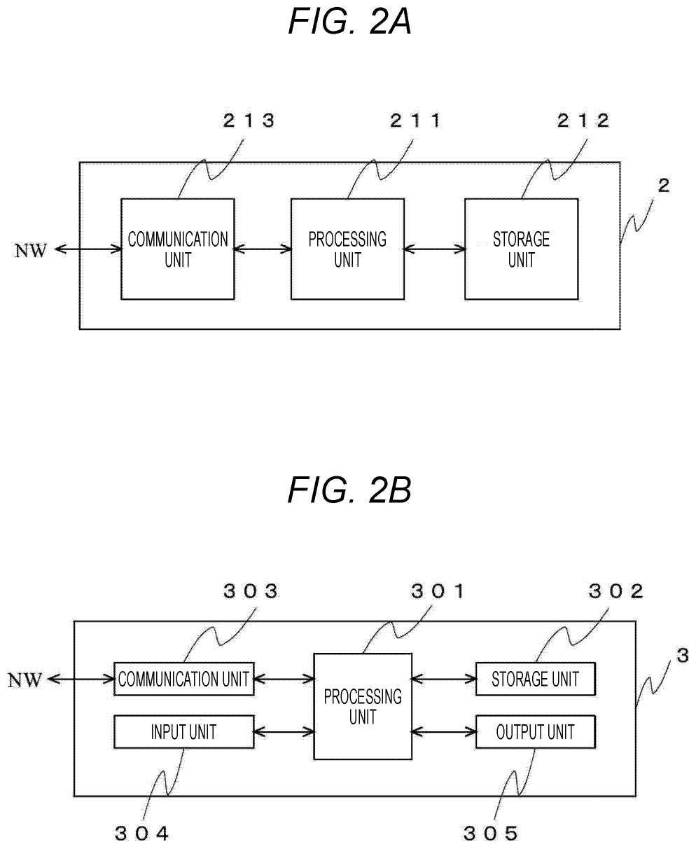

FIG. 2A illustrates a hardware configuration diagram of the real estate information matching system. The real estate information matching device 2 includes a processing unit 211 using a calculating device such as a central processing unit (CPU), a storage unit 212 using a hard disc drive (HDD), a read only memory (ROM), a random access memory (RAM), or the like, and a communication unit 213 for communicating with an external device via a network NW. The storage unit 212 stores a real estate information matching program and various data. The communication unit 213 performs communication control with the network NW and performs processing necessary for data communication with various devices. When the real estate information matching program is executed by the processing unit 211, a functional configuration described later is realized in the computer. The real estate information matching device 2 can function as the above described functional configuration. The real estate information matching device 2 can be configured as a computer device such as a server device.

The storage unit 212 stores the customer information, the condition information, and the real estate information illustrated in FIGS. 3A to 3C. In the present embodiment, the storage unit 212 stores the customer information illustrated in FIG. 3A such as a name, an e-mail address, a telephone number, and an address of a customer. In the present embodiment, the information stored as the customer information is information regarding the customer other than the condition information that is a condition of the real estate information to be delivered, however, the information included in the condition information such as the customer location information may be included in the customer information and stored as the information regarding the customer. Furthermore, in the data configuration illustrated in FIGS. 3A to 3C, the customer information is stored in association with the condition information based on the assigned ID, however, when the customer information is stored in association with the condition information, the customer information may include the condition information, or the condition information may include the customer information, i.e. the customer information may be stored in any data configuration. Furthermore, the customer information may be stored in association with a plurality of pieces of condition information. The condition information may include information regarding the customer such as age and occupation as long as the information serves as a condition of matching.

The condition information illustrated in FIG. 3B is information regarding a condition of real estate for which information is delivered to a customer, and includes information regarding a condition of real estate information to be delivered, such as the customer location information and the range condition information. In the present embodiment, the condition information is information regarding the condition of the real estate information that the customer desires to deliver presented by the customer, however, it may be information regarding the condition of the real estate that the customer seems to desire to deliver the information or the like presented by a deliverer such as a real estate company that delivers the real estate information to the customer. In addition, the customer location information included in the condition information is information related to the location of the real estate currently occupied by the customer, and includes the customer location which is a location of the real estate currently occupied by the customer and the condition position information which is position information at the customer location. In the present embodiment, the customer location is a location of a business facility to which the customer belongs, however, it may be the location of the nearest station of the customer, the address of the customer, or the like as long as it is the address of the real estate currently occupied by the customer. In the present embodiment, the customer location information is included in the condition information and stored, however, it may be included in the customer information and stored. Furthermore, the position information such as latitude and longitude at the customer location acquired by the position information acquiring part 203 is stored in the storage unit 212 as the condition position information included in the customer location information.

Furthermore, in the present embodiment, the range condition information is information regarding the condition of the range of the real estate to which the information set by the customer is delivered, however, it may be information regarding the condition of the range set for each business type of the customer, such as a range with a radius of about 500 meters in a case where the business type of the customer is a medical profession. Furthermore, in the present embodiment, the condition regarding the range is set as a range within a radius of several meters from the customer location, which is the location of the real estate currently occupied by the customer, the condition may be set to be a district including the customer location as a range.

FIG. 3C illustrates real estate information. In the present embodiment, the real estate information acquired by the real estate information acquiring processing and stored in the storage unit 212 includes information such as a real estate location, latitude and longitude information, a real estate type, a sales price, and a size of the real estate as the information regarding the real estate, the real estate information may include information regarding a real estate information site where the real estate information has been collected, access from a station, map information, a floor plan, pictures regarding an exterior, an interior, and the like, presence or absence of a parking lot, a building age in the case of the information regarding the real estate, however, it may include a floor number, room number, a rent, name of real estate, a building age, and the like in the case of an apartment or the like, and it may include information regarding a land restriction such as a building coverage ratio, a floor area ratio, and a use area in the case of a detached house or a land. In addition, the real estate information includes real estate position information that is position information at the real estate location acquired by the position information acquiring part 203. In the present embodiment, the type of real estate is a type of real estate itself such as land, a detached house, and an apartment, however, it may be a type classified with respect to uses of real estate such as a store, a clinic, and an office. In addition, the position information at the real estate location acquired by the position information acquiring part 203 is stored in the storage unit 212 as the real estate position information included in the real estate location information. In addition, as illustrated in FIG. 3C, the table of the real estate information may include an item with no entry such that the item of the real estate name is blank when the type of real estate is land.

In addition, the real estate information matching device 2 may have a function of using the real estate information stored in the storage unit 212, such as calculation of an appropriate sales price, evaluation of real estate, and analysis of a supply status of real estate for each region, based on the real estate information stored in the storage unit 212.

FIG. 2B is a diagram illustrating an example of a hardware configuration of the user terminal 3. The user terminal 3 includes, as a hardware configuration, a processing unit 301, a storage unit 302, a communication unit 303, an input unit 304, and an output unit 305. The processing unit 301 includes a calculating device such as a CPU and controls processing of the user terminal 3. The storage unit 302 includes an HDD, a RAM, a ROM, and the like, and stores an application or the like for cooperating with the real estate information matching device 2. The communication unit 303 controls communication with the network NW. The input unit 304 is a touch panel, a mouse, a keyboard, or the like, and inputs an operation request by the user to the processing unit 301. The output unit 305 is a display or the like, and outputs content to be reproduced, a result of processing by the processing unit 301, and the like. In the present embodiment, the user terminal 3 is configured using a computer terminal such as a personal computer, a smartphone, or a tablet terminal.

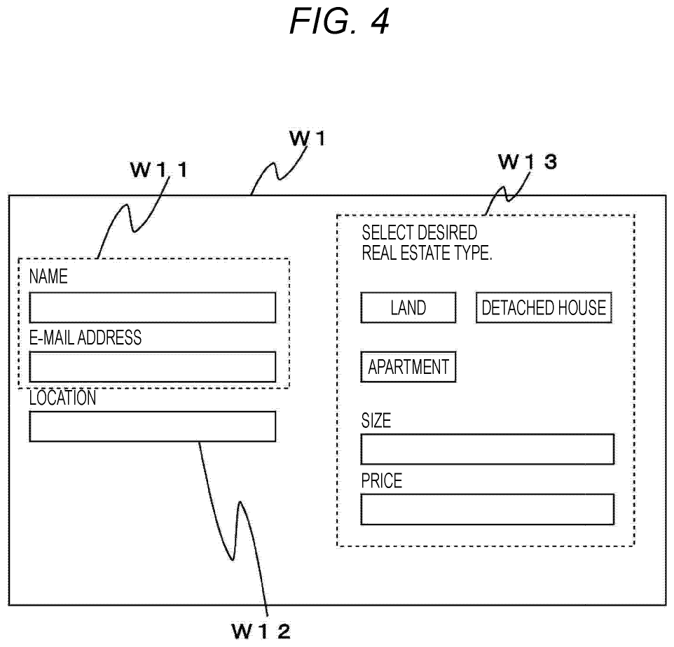

FIG. 4 illustrates a screen display example of a condition information input screen W1 for inputting condition information in the user terminal 3. FIG. 4 is a screen display example in the present embodiment, and does not limit the configuration of the screen. In addition, although the condition information input screen W1 illustrated in FIG. 4 is a screen when the customer receives condition information regarding the condition of the real estate for which information is delivered, it may be used as a screen for receiving condition information input by a person other than the customer such as a deliverer who delivers the real estate information to the customer. In the present embodiment, the condition information input screen W1 for receiving the input of the condition information is displayed as a web page.

The condition information input screen W1 includes a customer information receiving part W11 that receives information on a customer as the condition information, a location receiving part W12 that receives the customer location, and a desired condition receiving part W13 that receives information on real estate desired by the customer. The customer information receiving part W11 is an input part for receiving information regarding a customer such as a name and an e-mail address. In the present embodiment, the received customer information is a name and an e-mail address, however, it may be a telephone number, an occupation type, or the like. The location receiving part W12 is an input part for receiving an input of the customer location that is the location of the real estate currently occupied by the customer. In addition, the desired condition receiving part W13 is an input part for receiving a condition regarding real estate for which the customer desires to receive information. In the present embodiment, the desired condition receiving part W13 receives input of information regarding the classification of real estate, the size of real estate, and the price as the conditions of the real estate for which information is desired to be delivered, however, it may receive input of condition information regarding conditions other than the conditions illustrated in the condition information input screen W1, such as a distance from a station, presence or absence of a parking lot, and conditions of a range such as a district and a distance from the customer location.

FIG. 5 illustrates a display example of the delivering drawing generated by the drawing part 204. In the present embodiment, the delivering drawings are image data related to drawings such as fliers for delivering real estate information to a customer, generated based on the real estate information extracted by the matching processing, and are delivered to the customer by being mailed as an e-mail by the delivering part 205 or a printed matter.

Although the delivering drawing illustrated in FIG. 5 is a delivering drawing related to sales of land, and is a drawing including display of information on a real estate location, information on traffic, a price, property detailed information, detailed information on land such as an area of the land and restrictions including a building coverage ratio and a floor area ratio of land, information on facilities such as water and gas, map information, pictures related to an exterior and an interior, a floor plan, and a description of real estate, the delivering drawing may include display of a distance from a nearest station, an age of a building, a room number, and the like as long as the information is related to real estate. In the present embodiment, the delivering drawings are generated by arranging the real estate information for each item in a predetermined place. Furthermore, in the present embodiment, the drawing part 204 generates the delivering drawing by arranging a drawing that can display the shape, size, and the like of a section of land acquired as the real estate information, however, it may further generate a land drawing for displaying the shape and area of land from information such as the land area and the length of the outer periphery of the land acquired as the real estate information, and generate the delivering drawing by arranging the generated drawing. Although the drawing part 204 generates the delivering drawing related to the sale of the land illustrated in FIG. 5, the delivering drawing having a similar configuration may be generated for a rental agreement or the like.

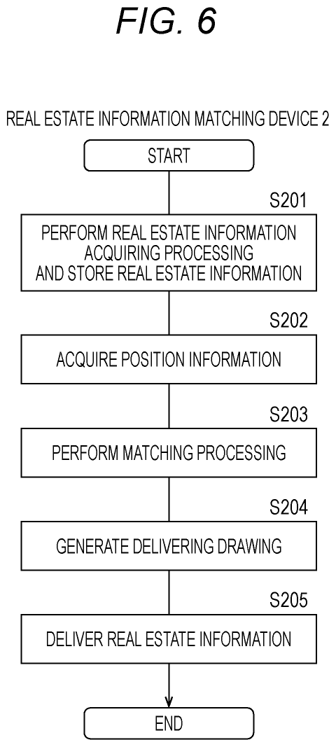

FIG. 6 illustrates a flow related to matching processing of real estate information. In the present embodiment, matching processing between a customer who operates the user terminal 3 and real estate information is performed. The flow of the processing illustrated in FIG. 6 is an example of the flow in the present embodiment, and the order of the processing is not limited.

FIG. 6 illustrates a flow related to matching processing of real estate information. When the acquiring part 201 performs the real estate information acquiring processing, acquires the real estate information, and stores the acquired real estate information in the storage unit 212 (S201), the position information acquiring part 203 acquires the position information at the customer location and stores the acquired position information as the condition position information included in the customer location information, acquires the position information at the real estate location and stores the acquired position information in the storage unit 212 as the real estate position information included in the real estate location information (S202). In the present embodiment, the condition position information and the real estate position information are information related to latitude and longitude. The matching part 202 performs matching processing of extracting real estate information satisfying conditions from the real estate information acquired based on the condition information stored in the storage unit 212 (S203). The drawing part 204 generates a delivering drawing as illustrated in FIG. 5 from the extracted real estate information (S204), and the delivering part 205 delivers the real estate information (S205). In the present embodiment, the delivering part 205 delivers the real estate information by transmitting the delivering drawing based on the real estate information as an e-mail.

Although the matching processing in FIG. 6 is a flow when the matching processing regarding the latest real estate information acquired by the real estate information acquiring processing is performed, the matching processing in which condition information is input from the user terminal 3 operated by the customer via the condition information input screen W1 and information is extracted from the real estate information stored in the storage unit 212 based on the input condition information may be performed in a similar flow.

### REFERENCE SIGNS LIST

1 real estate information matching system

2 real estate information matching device

3 user terminal

201 acquiring part

202 matching part

203 position information acquiring part

204 drawing part

205 delivering part

1. A real estate information matching system for delivering real estate information suitable for each customer,
the real estate information matching system comprising: a storage unit; an acquiring part; and a matching part,
wherein the storage unit stores condition information with respect to a condition of a real estate for which information is delivered to a customer including customer location information with respect to a location of a real estate currently occupied by the customer,
the condition information includes a range condition information with respect to a predetermined range to be set as the condition, and
the range condition information is information on a condition of a range to be set for a business type of a customer,
wherein the acquiring part performs real estate information acquiring processing acquiring real estate information including real estate location information with respect to a location of a real estate, and
wherein the matching part performs matching processing extracting real estate information satisfying the condition from the real estate information based on the condition information, and
the matching processing includes determination processing that determines whether a location of a real estate exists within a predetermined range set by the range condition information from the location of the customer based on the real estate location information, the customer location information, and the range condition information.

2. The real estate information matching system according to claim 1, further comprising a position information acquiring part,
wherein the real estate location information includes real estate position information that is position information of a real estate,
the customer location information includes a customer location that is a location of the real estate currently occupied by the customer,
the real estate location information includes a real estate location, and
the position information acquiring part acquires position information of the customer location to store as condition position information included in the customer location information and
acquires position information of the real estate location to store as real estate position information included in the real estate location information.

3. The real estate information matching system according to claim 1,
wherein the acquiring part performs processing that collects real estate information via a network as real estate information acquiring processing.

4. The real estate information matching system according to claim 1, further comprising a drawing part,
wherein the drawing part generates a delivering drawing being capable of displaying real estate information extracted by the matching processing from the real estate information extracted by the matching processing.

5. The real estate information matching system according to claim 1,
further comprising a delivering part, wherein when the matching part extract the real estate information by the matching processing, the delivering part transmits the real estate information with respect to an extracted real estate as an e-mail.

6. The real estate information matching system according to claim 2,
wherein the customer location is a location of a business facility to which a customer belongs.

7. A real estate information matching method for delivering real estate information suitable for each customer, the method comprising:
a storage unit stores condition information with respect to a condition of a real estate for which information is delivered to a customer including customer location information with respect to a location of a real estate currently occupied by a customer,
wherein the condition information includes a range condition information with respect to a predetermined range to be set as the condition, and
the range condition information is information on a condition of a range to be set for a business type of a customer;
a step of performing real estate information acquiring processing acquiring real estate information including real estate location information with respect to a location of a real estate; and
a step of performing matching processing extracting real estate information satisfying the condition from the real estate information based on the condition information, wherein the matching processing includes determination processing that determines whether a location of a real estate exists within a predetermined range set by the range condition information from a location of a customer based on the real estate location information, the customer location information, and the range condition information, and
wherein the acquiring processing and the matching processing are executed by a computer.
